(19) United States
(12) Patent Application Publication
(10) Pub. No.: US 2021/0041643 A1
(43) Pub. Date: Feb. 11, 2021

(54) QUICK RELEASE COUPLER FOR FIBER OPTIC CONNECTIONS

(71) Applicant: Senko Advanced Components, Inc., Marlborough, MA (US)

(72) Inventor: Jeffrey GNIADEK, Oxford, ME (US)

(73) Assignee: Senko Advanced Components, Inc., Marlborough, MA (US)

(21) Appl. No.: 16/989,763

(22) Filed: Aug. 10, 2020

Related U.S. Application Data
(60) Provisional application No. 62/884,449, filed on Aug. 8, 2019.

(51) Int. Cl. G02B 6/38

(52) U.S. Cl. CPC G02B 6/3898; G02B 6/3893; G02B 6/3849

(57) ABSTRACT

A fiber optic connector for making an optical connection with a second fiber optic connector includes a connector housing that mates with the second fiber optic connector free of fixed attachment thereto. A quick release coupler forms a quick release connection with the second fiber optic connector when the second fiber optic connector mates with the connector housing. The quick release coupler includes a mounting base coupled to the connector housing and opposing first and second retainers attached to the mounting base. The first and second retainers engage the second fiber optic connector when the second fiber optic connector mates with the connector housing to form the quick release connection with the second fiber optic connector.

### CROSS-REFERENCE TO RELATED APPLICATION

This application claims priority to U.S. Provisional App. No. 62/884,449, filed Aug. 8, 2019, and U.S. Design patent application Ser. No. 29/745,662, filed Aug. 7, 2020, which claims priority to U.S. Provisional App. No. 62/884,449, filed Aug. 8, 2019 the entireties of which are hereby incorporated by reference.

### FIELD

The present disclosure generally relates to fiber optic connections, and, more specifically, to a quick release coupler for securing a fiber optic connection.

### BACKGROUND

Optical connectors are used within optical communication networks to interconnect optical cables to optical devices or other optical cables. Optical connections typically involve two optical connectors connected together. These optical connectors frequently include latches, or some other means, to secure the two optical connectors together and inhibit the optical connectors from disconnecting from one another.

### SUMMARY

In one aspect, a fiber optic connector for making an optical connection with a second fiber optic connector comprises a connector housing configured to mate with the second fiber optic connector free of fixed attachment of the connector housing with the second fiber optic connector. A quick release coupler is configured to form a quick release connection with the second fiber optic connector when the second fiber optic connector mates with the connector housing. The quick release coupler includes a mounting base coupled to the connector housing and opposing first and second retainers attached to the mounting base. The first and second retainers are configured to engage the second fiber optic connector when the second fiber optic connector mates with the connector housing to form the quick release connection with the second fiber optic connector.

In another aspect, a quick release coupler for forming a quick release connection with a second fiber optic connector when the second fiber optic connector mates with a first fiber optic connector comprises a mounting base configured to attached to the first fiber optic connector. Opposing first and second retainers are attached to the mounting base. The first and second retainers project distally from the mounting base and are configured to engage the second fiber optic connector when the second fiber optic connector mates with the first fiber optic connector to form the quick release connection with the second fiber optic connector.

Other objects and features of the present disclosure will be in part apparent and in part pointed out hereinafter.

### BRIEF DESCRIPTION OF THE DRAWINGS

FIG. 1 is a perspective of first and second fiber optic connectors shown prior to connection according to one embodiment of the present disclosure;

FIG. 2 is a perspective of the second fiber optic connector;

FIG. 3 is a perspective of the first fiber optic connector;

FIG. 4 is a perspective of a quick release coupler according to one embodiment of the present disclosure;

FIG. 5 is aside elevation of the first and second fiber optic connectors aligned with one another for forming a fiber optic connection;

FIG. 6 is a section of the first and second fiber optic connectors taken in a plane including line 6-6 in FIG. 5;

FIG. 7 is similar to FIG. 6 with the first and second fiber optic connectors moved closer to being mated than in FIG. 6;

FIG. 8 is a side elevation of the first and second fiber optic connectors fully mated to form a fiber optic connection;

FIG. 9 is a section of the first and second fiber optic connectors taken in a plane including line 9-9 in FIG. 8.

Corresponding reference characters indicate corresponding parts throughout the drawings.

### DETAILED DESCRIPTION

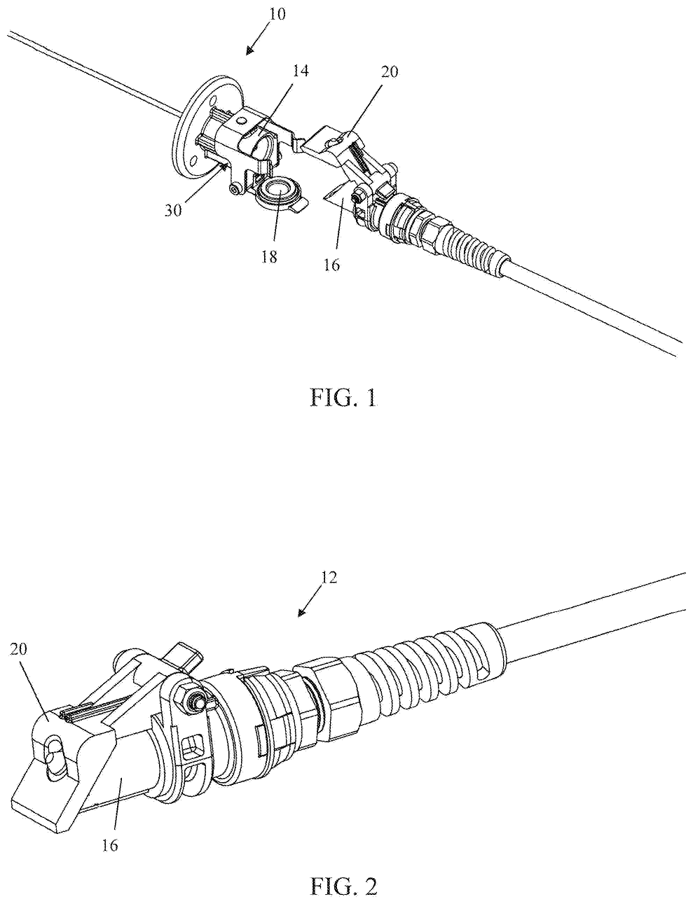

Referring to FIGS. 1-3, first and second fiber optic connectors 10, 12 for forming a fiber optic connector are generally shown. When coupled together, the first and second fiber optic connectors 10, 12 form an optical connection (e.g., a fiber optic connection) that enables communication (e.g., optical communication) between different fiber optic components (e.g., cables, devices, etc.) in an optical communications network. In the illustrated embodiment, the fiber optic connectors 10, 12 are attached to ends of fiber optic cables to couple the cables together, although other arrangements are within the scope of the present disclosure. In the illustrated embodiment, the first fiber optic connector 10 is a female fiber optic connector having a connector housing 14 configured to mate (e.g., receive) with the second fiber optic connector 12. Likewise, the second fiber optic connector 12 is a male fiber optic connector having a connector housing 16 configured to mate (e.g., be inserted into) the first fiber optic connector 10. When coupled together, the first and second fiber optic connectors 10, 12 (e.g., connector housings 14, 16) are free of fixed attachment to one another. The first and second fiber optic connectors 10, 12 each include dust covers 18, 20. The dust covers 18, 20 are removed or opened (FIG. 1) prior to the connection of the fiber optic connectors 10, 12. In the illustrated embodiment, the dust cover 18 of the first fiber optic connector 10 is pivotally mounted on the connector housing 14 by a fastener 42 (broadly, at least one fastener). Other configurations of the first and second fiber optic connectors 10, 12 are within the scope of the present disclosure. In one example, the connectors could make electrical or other types of connections instead of or in addition to an optical connection.

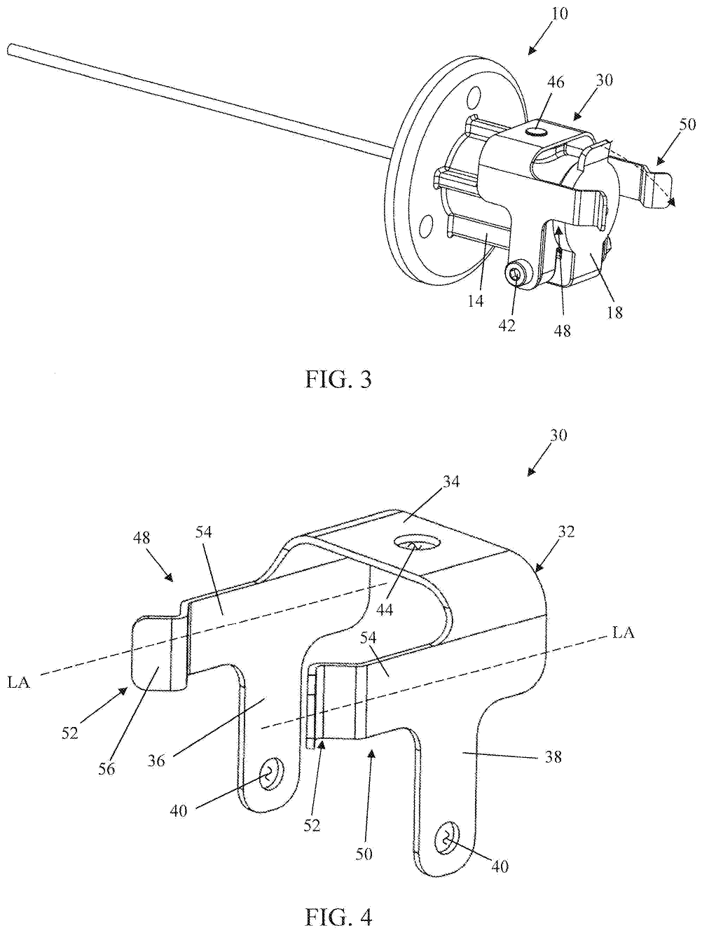

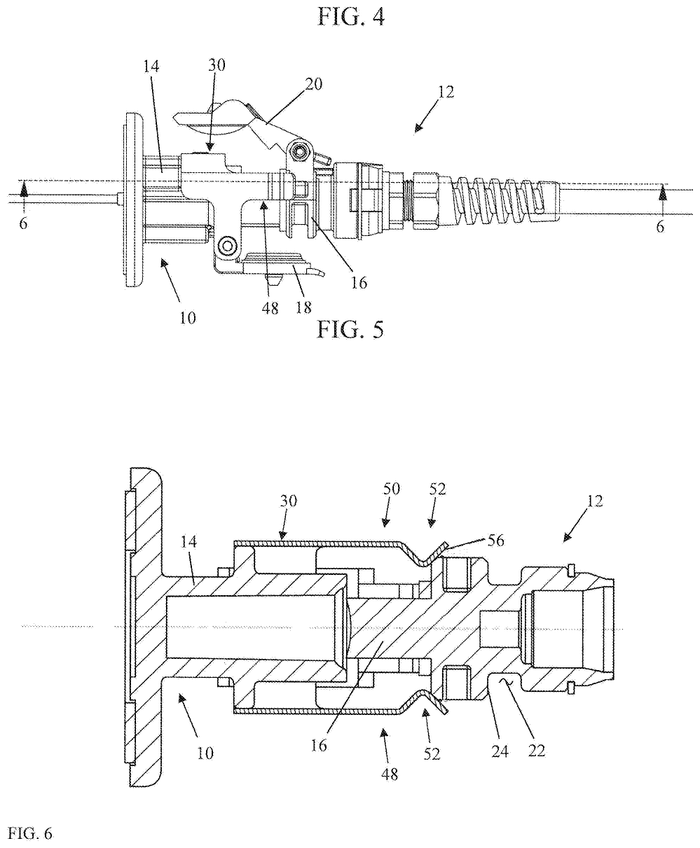

Referring to FIGS. 3 and 4, the first fiber optic connector 10 includes a quick release coupler 30 (e.g., a quick release connector). The quick release coupler 30 is configured to form a quick release connection with the second fiber optic connector 12 when the second fiber optic connector mates with (e.g., couples to) the first fiber optic connector 10. The quick release coupler 30 maintains the coupling between the first and second fiber optic connectors 10, 12 and permits the first and second fiber optic connectors to be easily and quickly coupled and decoupled. In the illustrated embodiment, the quick release coupler 30 is a bracket.

The quick release coupler 30 includes a mounting base 32. The mounting base 32 is configured to attach to the connector housing 14 of the first fiber optic connector 10. The mounting base 32 includes a base flange 34 and opposite first and second side flanges 36, 38 (e.g., shoulders) extending from opposite side edge margins of the base flange 34. The base flange 34 and first and second side flanges 36, 38 are all generally planar. The first and second side flanges 36, 38 are generally parallel with one another. Together the base flange 34 and first and second side flanges 36, 38 for the generally U-shape of the mounting base 32. Accordingly, the mounting base 32 defines a receiving space sized and shaped to receive the connector housing 14 of the first fiber optic connector 10. As shown in FIG. 3, the mounting base 32 generally surrounds the connector housing 14 of the first fiber optic connector 10 when attached to the connector housing. The mounting base 32 and the connector housing 14 each include at least one fastener opening 40 through which the fastener 42 (e.g., a bolt with a nut) (broadly, at least one fastener) extends to attach the quick release coupler 30 to the connector housing of the first fiber optic connector 10. In the illustrated embodiment, each side flange 36, 38 includes (e.g., defines) a fastener opening 40 adjacent the free end thereof. The quick release coupler 30 and the dust cover 18 are mounted on the connector housing 14 of the first fiber optic connector 10 at the same location by the fastener 42. To inhibit the quick release coupler 30 from rotating about the fastener 42, the mounting base 34 includes an opening 44 through which a projection 46 of the connector housing 14 extends into (and through). This secures the quick release coupler 30 to the connector housing 14 of the first fiber optic connector 10 and inhibits the coupler from rotating about the fastener 42.

The quick release coupler 30 includes first and second retainers 48, 50 (broadly, at least one retainer) configured to maintain (e.g., retain) the coupling between the first and second fiber optic connectors 10, 12. The first and second retainers 48, 50 are configured to engage the second fiber optic connector 12 when the second fiber optic connector 12 mates with the first fiber optic connector 10 to form the quick release connection with the second fiber optic connector 12. The first and second retainers 48, 50 oppose (e.g., face) one another. The first and second retainers 48, 50 are spaced apart and define a space to permit the connector housing 16 of the second fiber optic connector 12 to be inserted therebetween.

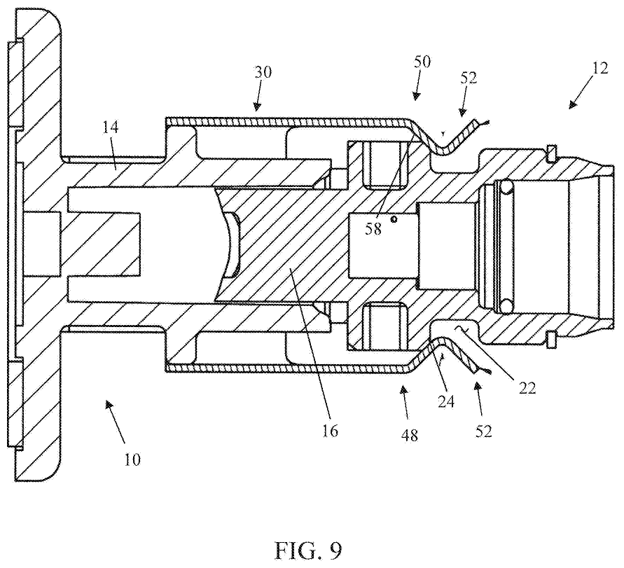

Referring to FIG. 4, the first retainer 48 will be described in further detail with the understanding that the second retainer 50 has essentially the same construction (e.g., the second retainer is a mirror image of the first retainer). The first retainer 48 engages the second fiber optic connector 12 to hold the second fiber optic connector in place relative to the first fiber optic connector 10 when the first and second fiber optic connectors 10, 12 are coupled together. The first retainer 48 is attached to the mounting base 32 and, in particular, the first side flange 36. The first retainer 48 projects distally from the mounting base 32. When the first and second fiber optic connector 10, 12 are coupled together, the first retainer 48 generally overlies and extends along the second fiber optic connector 12. The first retainer 48 includes a detent or catch 52 configured to engage the second fiber optic connector 12 when the second fiber optic connector mates with the first fiber optic connector 10. The catch 52 engages the second fiber optic connector 12 to maintain the optical connection between the first and second fiber optic connectors 10, 12. The connector housing 16 of the second fiber optic connector 12 includes a recess 22 and a shoulder 24 (e.g., distally facing surface) at least partially defining the recess (FIG. 6). The recess 22 and shoulder 24 extend at least partially circumferentially around the connector housing 16. The catch 52 of the first retainer 48 is disposed in the recess 22 of the connector housing 16 and engages the shoulder 24 (FIG. 9) to hold the second fiber optic connector 12 in place and maintain the optical connection. The catch 52 of the first retainer 48 engages the connector housing 16 of the second fiber optic connector 12 to prevent the second fiber optic connector from moving distally and decoupling (e.g., inadvertently decoupling) from the first fiber optic connector 10.

The first retainer 48 is configured to form a quick release snap-fit connection with the second fiber optic connector 12. The first retainer 48 is resiliently deflectable. The first retainer 48 includes a leg 54. The leg 54 is flexible (e.g., resiliently deflectable). The leg 54 extends from the mounting base 32 (e.g., the first side flange 36). The leg 54 has a longitudinal axis LA that extends proximally/distally. The catch 52 of the first retainer 48 is disposed at or adjacent to the free (e.g., distal) end of the leg 54. The catch 52 generally extends inward (e.g., toward the second retainer 50) so that the catch engages the second fiber optic connector 12.

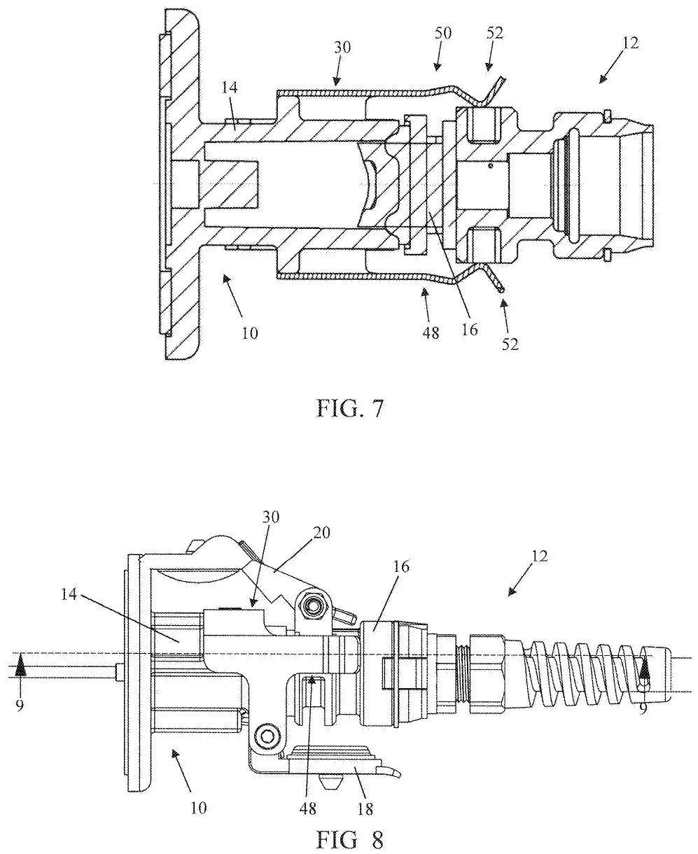

Referring to FIGS. 5-9, the first retainer 48 is configured to be deflected outwardly (e.g., away from the second retainer 50) by the second fiber optic connector 12 when the second fiber optic connector 12 mates with (e.g., couples to) the connector housing 14 of the first fiber optic connector 10. FIGS. 5 and 6 show the first and second connectors 10, 12 generally aligned with one another before the second connector 12 begins to be inserted into the first fiber optic connector 10. In these figures, the first retainer 48 is shown in an undeflected or at rest position. As the second fiber optic connector 12 is inserted into the connector housing 14 of the first fiber optic connector 10, the connector housing 16 of the second fiber optic connector 12 deflects the first retainer 48 outward (FIG. 7). The catch 52 includes a first or distal engagement surface 56 to facilitate the deflection of the first retainer 48. The first engagement surface 56 is disposed at a non-orthogonal angle, such as about 45 degrees, relative to the longitudinal axis LA of the leg 54. The first engagement surface 56 engages the second fiber optic connector 12 to deflect the leg 54 when the second fiber optic connector mates with the connector housing 14 of the first fiber optic connector 10. The second fiber optic connector 12 deflects the first retainer 48 until the recess 22 aligns with the catch 52, at which point the first retainer returns or snaps back inward, toward the at rest position, moving the catch inward into the recess 22 and engaging the shoulder 24 to maintain the optical connection (FIGS. 8 and 9). The process of coupling the first and second fiber optic connectors 10, 12 is shown sequentially by FIGS. 5-9.

The first retainer 48 is configured to be deflected outwardly (e.g., away from the second retainer 50) by the second fiber optic connector 12 when the second fiber optic connector disconnects or decouples from the connector housing 14 of the first fiber optic connector 10. As the second fiber optic connector 12 is removed from the connector housing 12 of the first fiber optic connector 10 (e.g., is moved distally), the connector housing 16 of the second fiber optic connector deflects the first retainer 48 outward. The catch 52 includes a second or proximal engagement surface 58 (FIG. 9) to facilitate the deflection of the first retainer 48. The second engagement surface 58 is disposed at a non-orthogonal angle, such as about 45 degrees, relative to the longitudinal axis LA of the leg 54. The second engagement surface 58 engages the second fiber optic connector 12 to deflect the leg 54 when the second fiber optic connector disconnects from the connector housing 14 of the first fiber optic connector 10. The second fiber optic connector 12 is moved distally until the second fiber optic connector is disconnected from the first fiber optic connector 10. The process of decoupling the first and second fiber optic connectors 10, 12 is shown sequentially by the reverse order of FIGS. 5-9.

In the illustrated embodiment, the first retainer 48 is integrally formed with the mounting base 32 (e.g., the quick release connector 30 is a single piece of material). In one embodiment, the quick release connector 30 is formed by stamping from sheet metal and forming into shape. Other configurations of the quick release connector 30 are within the scope of the present disclosure.

The first and second retainers 48, 50 are configured to resist disconnection of the second fiber optic connector 12 from the connector housing 14 of the first fiber optic connector 10 upon application of a removal force up to a first removal force threshold. Preferably, the first removal force threshold is larger than forces the optical connection will experience during normal use but low enough to enable the manual decoupling of the first and second fiber optic connectors 10, 12 by a user. The first and second retainers 48, 50 are also configured to resiliently deflect to permit nondestructive removal of the second fiber optic connector 12 from the first fiber optic connector 10 upon application of a second removal force greater than the first removal force. In this manner, the quick release coupler 30 forms a quick release connection with the second fiber optic connector 12 because the second fiber optic connector can be decoupled from the first fiber optic connector 10 with the application of a sufficient amount of force (e.g., the second removal force) applied in a direction opposite to the direction which produced mating of the first and second connectors. In conventional arrangements, latches must first be moved separately from movement of the connector to release connection before two fiber optic connectors can be decoupled. This may lead to destructive removal of the fiber optic connectors if the latches are not first released and the decoupling force is sufficient to break the latches or other parts of the connectors. Moreover, by permitting nondestructive removal of the second fiber optic connector 12 from the first fiber optic connector 10, the quick release coupler 30 enables the optical connection between the first and second fiber optic connectors 10, 12 to be broken in the event a decoupling force (e.g., second removal force) is unintentionally applied to the optical connection before the fiber optic connectors are manually disconnected. For example, with the proliferation of electric vehicles, fiber optic connectors (such as first and second fiber optic connectors 10, 12) may be used to connect an electric vehicle (not shown) to an optical communications network in order to transfer information therebetween. In the event a driver mistakenly drives the electric vehicle away while the electric vehicle is still connected to the optical communications network via the first and second fiber optic connectors 10, 12, the quick release connector 30 of the present disclosure permits the nondestructive disconnection of the first and second fiber optic connectors 10, 12. A similar situation with conventional fiber optic connectors with latches would likely result in the destruction or damaging of conventional fiber optic connectors or other components (e.g., cables). Moreover, the quick release coupler 30 can be used to releasably grasp connectors (not shown) having different structures than shown herein.

Modifications and variations of the disclosed embodiments are possible without departing from the scope of the invention defined in the appended claims. For example, where specific dimensions are given, it will be understood that they are exemplary only and other dimensions are possible.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A fiber optic connector for making an optical connection with a second fiber optic connector, the fiber optic connector comprising:
a connector housing configured to mate with the second fiber optic connector free of fixed attachment of the connector housing with the second fiber optic connector;
a quick release coupler configured to form a quick release connection with the second fiber optic connector when the second fiber optic connector mates with the connector housing, the quick release coupler including a mounting base coupled to the connector housing and opposing first and second retainers attached to the mounting base, the first and second retainers configured to engage the second fiber optic connector when the second fiber optic connector mates with the connector housing to form the quick release connection with the second fiber optic connector.

2. The fiber optic connector of claim 1, wherein the first and second retainers are configured to resist disconnection of the second fiber optic connector from the connector housing upon application of a removal force up to a first removal force threshold and configured to resiliently deflect to permit nondestructive removal of the second fiber optic connector upon application of a second removal force greater than the first removal force threshold.

3. The fiber optic connector of claim 2, wherein the first and second retainers are configured to be deflected away from one another by the second fiber optic connector when the second fiber optic connector mates with the connector housing.

4. The fiber optic connector of claim 3, wherein the first and second retainers are configured to be deflected away from one another by the second fiber optic connector when the second fiber optic connector disconnects from the connector housing.

5. The fiber optic connector of claim 4, wherein each of the first and second retainers comprise flexible legs.

6. The fiber optic connector of claim 5, wherein each flexible leg extends from the mounting base.

7. The fiber optic connector of claim 6, wherein each flexible leg includes catch configured to engage the second fiber optic connector when the second fiber optic connector mates with the connector housing.

8. The fiber optic connector of claim 7, wherein each catch includes a first engagement surface disposed at a non-orthogonal angle relative to a longitudinal axis of the flexible leg, the first engagement surface configured to be engaged by the second fiber optic connector to deflect the flexible leg when the second fiber optic connector disconnects from the connector housing.

9. The fiber optic connector of claim 8, wherein each catch includes a second engagement surface disposed at a non-orthogonal angle relative to the longitudinal axis of the flexible leg, the second engagement surface configured to be engaged by the second fiber optic connector to deflect the flexible leg when the second fiber optic connector mates with the connector housing.

10. The fiber optic connector of claim 1, further comprising a fastener, wherein the mounting base and the connector housing each include at least one fastener opening through which the fastener extends to attach the quick release coupler to the connector housing.

11. The fiber optic connector of claim 10, further comprising a dust cover pivotally mounted on the connector housing by said at least one fastener, the quick release connector and dust cover being mounted on the connector housing at the same location by said at least one fastener.

12. A quick release coupler for forming a quick release connection with a second fiber optic connector when the second fiber optic connector mates with a first fiber optic connector, the quick release coupler comprising:
a mounting base configured to attached to the first fiber optic connector; and
opposing first and second retainers attached to the mounting base, the first and second retainers projecting distally from the mounting base and being configured to engage the second fiber optic connector when the second fiber optic connector mates with the first fiber optic connector to form the quick release connection with the second fiber optic connector.

13. The quick release coupler of claim 12, wherein the first and second retainers are configured to resiliently deflect away from each other.

14. The quick release coupler of claim 13, wherein the first and second retainers are configured to be deflected away from one another by the second fiber optic connector when the second fiber optic connector mates with the connector housing.

15. The quick release coupler of claim 14, wherein the first and second retainers are configured to be deflected away from one another by the second fiber optic connector when the second fiber optic connector disconnects from the connector housing.

16. The quick release coupler of claim 15, wherein each of the first and second retainers comprise flexible legs.

17. The quick release coupler of claim 16, wherein each flexible leg extends from the mounting base.

18. The quick release coupler of claim 17, wherein each flexible leg includes catch configured to engage the second fiber optic connector when the second fiber optic connector mates with the connector housing.

19. The quick release coupler of claim 18, wherein each catch includes a first engagement surface disposed at a non-orthogonal angle relative to a longitudinal axis of the flexible leg, the first engagement surface configured to be engaged by the second fiber optic connector to deflect the flexible leg when the second fiber optic connector disconnects from the connector housing.

20. The quick release coupler of claim 19, wherein each catch includes a second engagement surface disposed at a non-orthogonal angle relative to the longitudinal axis of the flexible leg, the second engagement surface configured to be engaged by the second fiber optic connector to deflect the flexible leg when the second fiber optic connector mates with the connector housing.
